(19) United States
(12) Patent Application Publication
(10) Pub. No.: US 2023/0191423 A1
(43) Pub. Date: Jun. 22, 2023

(54) PRODUCT TRANSFER SYSTEM

(71) Applicant: Frewitt fabrique de machines SA, Granges-Paccot (CH)

(72) Inventors: Christian Rhême, Posieux (CH); Antoine Virdis, Ferpicloz (CH)

(21) Appl. No.: 18/082,712

(22) Filed: Dec. 16, 2022

(30) Foreign Application Priority Data
Dec. 22, 2021 (CH) 070774/2021

(51) Int. Cl. B02C 23/02

(52) U.S. Cl. CPC B02C 23/02

(57) ABSTRACT

The present invention relates to a system for transferring product, particularly in a vacuum processing chamber, said transfer system comprising:
a body defining a cavity, and
a transfer wheel accommodated in said cavity and provided with at least one pocket at its periphery, the wheel being adapted to rotate so as to feed product from said intake zone to said distribution zone, wherein the transfer wheel and the body co-operate to form a substantially air-tight barrier between the two zones. The invention also relates to a processing system including such a transfer system and a corresponding processing method.

### TECHNICAL FIELD

The present invention relates to the vacuum processing of products, in particular products in powder form.

It relates in particular to a system for such processing, especially, but not limited to, a vacuum grinding system.

### STATE OF THE ART

Grinding systems are commonly used in the food and pharmaceutical industries. The grinding chamber, in which the product is ground, is advantageously put under vacuum to avoid altering the qualities of the product by oxidation.

Vacuum grinding systems are already known, for example from the document FR 2 628 007. However, these systems do not achieve a satisfactory yield or do not prevent a certain amount of oxidation of the product, which changes its essential qualities.

The applicant has recently developed a continuous vacuum grinding system, which operates by means of a system of inlet and outlet airlocks able to be put under vacuum and controlled by valves. By controlling the valves, a quantity of material can be transferred to be ground in the grinding chamber, which is kept under vacuum at all times. The disadvantage of this system is that it is relatively cumbersome.

The purpose of the present invention is to propose an alternative system to the above-mentioned system, which allows the product to be treated continuously and in an environment maintained under vacuum during the entire processing operation.

### DISCLOSURE OF INVENTION

The idea behind the present invention is to take advantage, for the management of the vacuum in a processing chamber, of the product distribution device typically used in such a chamber. The processing chambers are indeed provided, most of the time, with distribution devices of the rotary type or other, allowing to feed in a regular and homogeneous way the processing devices contained in the said chambers. However, these distribution devices do not play any role in the management of the pressure inside the chamber.

According to a first aspect, the invention relates to a system for transferring product, in particular for transferring product in a vacuum processing chamber, the transfer system comprising:

a body defining a cavity extending in a main direction, and

a transfer wheel accommodated at least partially in said cavity and separating in said main direction a product intake zone and a product distribution zone, the transfer wheel being provided with at least one pocket at its periphery and being adapted to rotate about an axis substantially orthogonal to said main direction so that said pocket brings product from said intake zone to said distribution zone,

the transfer system being characterized in that the transfer wheel and the body cooperate to form a substantially air-tight barrier between the intake zone and the distribution zone.

By co-operating to form a substantially air-tight barrier, it is meant that the maximum air flow rate between the intake zone and the distribution zone (between the wheel and the body) is less than or equal to 200 normal liters per minute (Nl/min), preferably less than or equal to 150 normal liters per minute (Nl/min), even more preferably less than or equal to 100 normal liters per minute (Nl/min).

In order to measure this maximum flow rate, it is possible, for example, to close the distribution zone and put it under vacuum using a pump, and at the same time measure with a flow meter, in the intake zone, the quantity of air sucked through the wheel under the effect of the vacuum pump.

The passage of air between the intake zone and the distribution zone is prevented or substantially limited, so that a pressure difference between the two zones can be kept substantially constant or, at least, can vary in proportions small enough to be compensated for by the use of a vacuum pump for example.

The transfer system according to the invention is, for example, particularly suitable for closing the inlet of a processing chamber. The distribution zone then corresponds to the interior of said processing chamber, which is advantageously under vacuum, in particular at an absolute pressure of between 0.05 and 0.3 bar. In this case, the intake zone typically contains product to be processed and, advantageously, forms the interior of a product reservoir, with the absolute pressure inside said reservoir typically equal to atmospheric pressure. In such a use, the transfer system allows the continuous feeding of the processing chamber, while guaranteeing the substantial maintenance of the pressure differential between the reservoir and the processing chamber and thus the vacuum inside said processing chamber. As mentioned above, a slight air leak between the reservoir and the processing chamber is not detrimental if it can be compensated for by the use of a vacuum pump in the processing chamber. Preferably, however, the maximum air flow between the two zones is minimized as much as possible, or even made zero.

The main direction of the transfer system corresponds to the overall direction of movement of the product in the system. In operation, this direction is generally (but not limited to) the vertical direction, with the intake zone located above the distribution zone.

Throughout this application, and in connection with the transfer wheel, an axial direction X is defined as a direction parallel to the axis of rotation X of the wheel.

A radial direction (for example Y) is also defined as a direction orthogonal to this axial direction.

A transverse plane is a plane normal to the axial direction.

The axis of rotation of the wheel is substantially orthogonal to the main direction, i.e., it is inclined by no more than 30 degrees to a plane normal to the main direction.

The wheel may be adapted to perform either a continuous or alternating rotational motion about its axis X. In other words, the wheel is not necessarily adapted to make a complete revolution about its axis. In the case of a reciprocating movement, the amplitude of rotation is sufficient for the at least one pocket to be filled with product in the intake zone and emptied in the distribution zone.

The transfer wheel is provided at its periphery with at least one pocket, which can be of very different shapes and sizes.

Understood by pocket, is any compartment forming a hollow in relation to the radial surface of the wheel and adapted to receive product, in particular a powder.

Advantageously, the transfer wheel is provided at its periphery with a plurality of pockets evenly distributed over the radial surface of the wheel.

In the following, the useful radial surface of the wheel is taken to mean the section of surface radially circumscribing the wheel and in which the pockets are made.

According to one example, the surface of the wheel co-operates in a form-fitting manner with the inner surface of the body. In particular, advantageously, the useful radial surface of the transfer wheel co-operates in a form-fit manner with a first radial interaction surface of the body on the side of its passage from the intake zone to the distribution zone and a second radial interaction surface of the body on the side of its passage from the distribution zone to the intake zone.

Advantageously, the curvilinear length, measured in a transverse plane, of each radial interface between the useful radial surface of the transfer wheel and a radial interaction surface of the body is at least equal to the maximum curvilinear length of the at least one pocket measured in a transverse plane.

When the wheel completes a full revolution about its axis, each pocket of the transfer wheel thus passes through an intermediate entry sector where the pocket faces the first radial interaction surface and is fully covered by said surface, and through an intermediate exit sector, where it faces the second radial interaction surface and is fully covered by said surface.

The transfer system must be configured to prevent or substantially limit air flow between the body and the transfer wheel. For this purpose, the transfer wheel and the body may, for example, co-operate by means of a dimensional fit and/or a seal system.

According to one example, the clearance between at least one of the first and second radial interaction surfaces and the useful radial surface of the transfer wheel can be made as small as possible, for example between 0.01 to 0.2 mm, preferably between 0.01 to 0.1 mm.

At the same time, the curvilinear length, measured in a transverse plane, of each radial interface between the useful radial surface of the transfer wheel and a radial interaction surface of the body is advantageously at least equal to 1/20 of the wheel circumference.

Alternatively or additionally, the wheel and the body can co-operate by means of at least one seal to achieve air tightness.

Preferably, at least one linear seal, preferably two linear seals, extending in the axial direction of the transfer wheel, is/are arranged on at least one of the first and second radial interacting surfaces of the body or on the useful radial surface of the transfer wheel.

According to an advantageous arrangement, the at least two linear seals are optionally spaced apart by a curvilinear distance—measured in a transverse plane—that is at least equal to, preferably greater than, the maximum curvilinear length of a wheel pocket measured in a transverse plane. Such an arrangement ensures that each pocket always communicates with only one of the inlet and outlet zones, even in a case where the body and wheel are not dimensionally adjusted. Thus, two seals formed on a radial interaction surface of the body delimit between them and with the wheel a dynamic airlock into which each pocket passes during the rotation of the wheel. In the case of seals formed on the radial surface of the wheel, two seals on either side of a pocket can co-operate with each radial interaction surface to form a dynamic seal.

To prevent the passage of air between the body and the side surfaces of the wheel, a circular seal may also be provided at each lateral end of said wheel. Circular seals may, for example, be arranged either on the outer radial surface of the wheel, on either side of the useful radial surface, or on the lateral end surfaces of the wheel.

A system of seals can, if necessary, be perfectly air-tight.

However, even if the flow of air between the body and the wheel is managed, such as by one or another solution described above or a combination of these solutions, some amount of air also passes through the pockets carrying the product. In particular, even when a pocket is full of powder, it still contains at least some air.

Particularly advantageously, to prevent such air from entering the processing chamber, the transfer system may include an air extraction system to extract the air contained in the at least one pocket before it arrives in the distribution zone.

According to one implementation example, this extraction system comprises at least one extraction conduit fluidly connected with a vacuum pump, and at least one filter to prevent product from exiting the pocket. The conduit is adapted to communicate with each pocket to be emptied at least when that pocket is on the intermediate intake sector, where it faces the first radial interaction surface of the body, i.e., as it passes from the intake area to the distribution area.

Advantageously, the extraction conduit may open onto said first radial interaction surface.

Alternatively, the extraction conduit may also be formed in the transfer wheel, the filter forming at least a portion of the bottom of said at least one pocket.

According to a second aspect, the invention relates to a system for vacuum processing of a product, especially a product in powder form, comprising:

a frame,

a processing chamber bounded by the frame and capable of being fluidly connected to a vacuum pump, the processing chamber being provided with an inlet for the introduction of product to be processed and an outlet for the discharge of processed product,

a product transfer system as defined above, arranged to close the inlet of the processing chamber, and

means for closing said outlet.

According to one example, the processing chamber is a grinding chamber which comprises a grinder.

According to one example, the processing system may include a second transfer system as defined above, arranged to close the outlet of the processing chamber. In this case, the product intake zone is the interior of the processing chamber and the distribution zone is a downstream zone where the product is recovered.

According to a third aspect, the invention also relates to a process for vacuum processing of a product by means of a processing system such as defined above, comprising at least one step a) during which the following are performed simultaneously:

the rotation of the transfer wheel for the continuous supply of product into the processing chamber previously put under vacuum and,

the continuous processing of the product fed by the transfer wheel.

According to one example, step a) further comprises extracting air from each pocket of the transfer wheel prior to its arrival in the distribution zone.

According to another example, step a) further comprises a suctioning of air contained in the processing chamber during the processing of the product.

According to another example, throughout step a), the absolute pressure differential between the intake zone and the processing chamber is maintained between 0.7 and 0.95 bar.

According to another example, during step a), the absolute pressure inside the processing chamber is maintained between 0.05 and 0.3 bar (with the absolute pressure outside the processing chamber and thus in the intake zone of the transfer system at the chamber inlet advantageously equal to atmospheric pressure).

Still other more specific aspects of the present invention are described below:

the inlet area may be a product reservoir, for example in the form of a hopper. In this case, the transfer wheel forms a wall of said product reservoir, and in particular its bottom wall,

the reservoir, the transfer wheel and the processing chamber may be vertically aligned, so that the at least one pocket is filled by gravity in the reservoir and emptied by gravity in the processing chamber,

at least one of the radial surface of the transfer wheel and the radial interaction surfaces may be made of a synthetic material, such as PTFE,

the pockets may be arranged in a staggered pattern on the useful radial surface of the wheel,

the pocket(s) may be hemispherical in shape,

the pocket(s) may extend in the axial direction, for example continuously over at least 50 percent of the axial length of the transfer wheel.

### BRIEF DESCRIPTION OF THE DRAWINGS

Other details of the invention will emerge more clearly from reading the description which follows, given with reference to the attached drawings in which:

FIG. 1 is an overall perspective view of a transfer system according to a first embodiment of the invention,

FIG. 2 is a partial perspective view of the transfer system of FIG. 1, along a main sectional plane parallel to the axis of rotation of the transfer wheel,

FIG. 3 is a partial perspective view of the transfer system of FIG. 1, in a main sectional plane orthogonal to the axis of rotation of the transfer wheel,

FIG. 4 is a partial view of the transfer system of FIG. 1, in a main sectional plane parallel to the axis of rotation of the transfer wheel, with the transfer wheel omitted to show the linear seals,

FIG. 5 shows a possible configuration of a radial seal at one lateral end of the wheel,

FIG. 6 shows the air evacuation system of FIG. 3, in cross section along the X-Y plane,

FIG. 7 is a partial view of a transfer system according to a second embodiment of the invention, according to a main sectional plane parallel to the axis of rotation of the transfer wheel,

FIG. 8 is a partial view of the transfer system of FIG. 7, according to a main sectional plane orthogonal to the rotational axis of the transfer wheel,

FIG. 9 is a schematic view of a processing system according to the invention.

### EMBODIMENT OF THE INVENTION

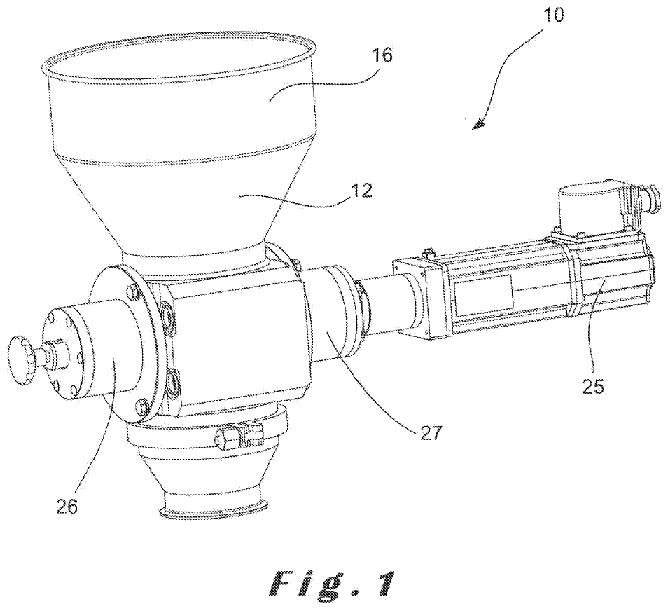

FIG. 1 is an overview of a product transfer system 10 according to a first embodiment of the invention.

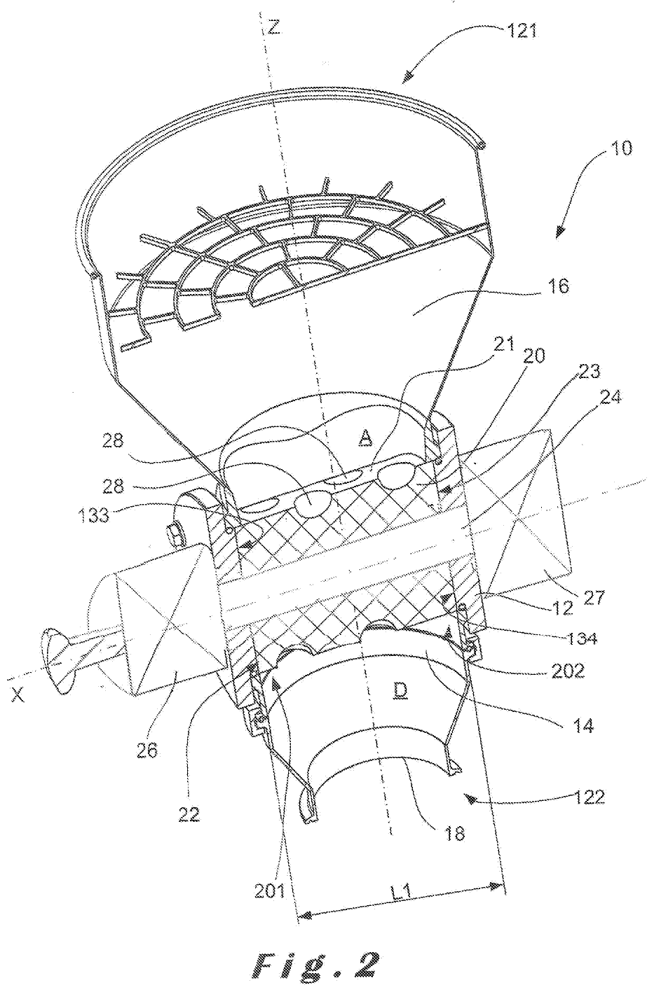

As seen in FIG. 2, this transfer system 10 includes a body 12 defining a cavity 14 extending along a principal direction Z.

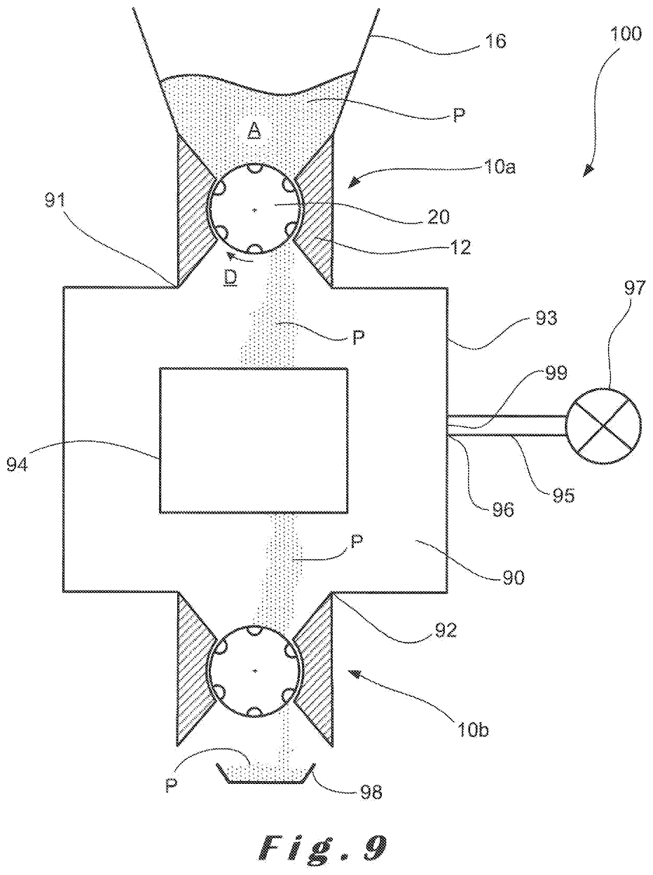

At its upper end 121, the body 12 forms a reservoir in the form of an inlet hopper 16 that can be filled with product. At its lower end 122, the body 12 has an opening 18 for the exit of the product, through which it can be attached, for example to a frame of a processing system as will be described in the following with reference to FIG. 9.

A transfer wheel 20 (hereinafter wheel) is accommodated in the cavity 14.

Within the cavity 14, in the main direction Z, the wheel 20 forms a separation between a product intake zone A and a product distribution zone D.

The product intake zone A is here the reservoir 16 formed by the hopper and whose bottom is constituted by the radial surface 21 of the wheel 20.

The distribution area D may be, in use, the interior of a product processing chamber.

The transfer wheel 20 is here integral with a shaft 24 adapted to rotate about its axis X under the action of a drive motor 25 visible in FIG. 1, by means of a set of bearings 26, 27.

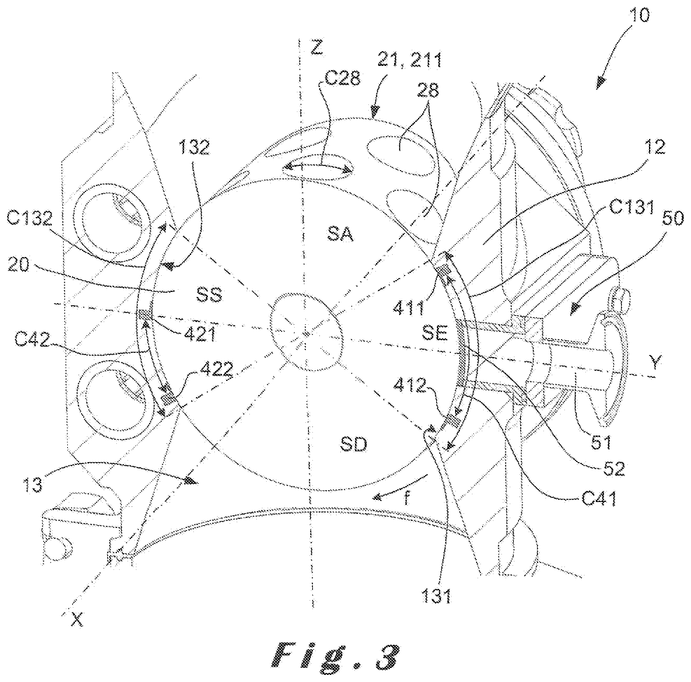

The transfer wheel 20 here has a straight cylinder shape, as is apparent in particular from FIG. 3.

It is thus delimited radially by a radial surface 21, and axially by a first lateral end surface 22 and a second lateral end surface 23 (hereinafter end surfaces 22, 23) substantially flat, orthogonal to the axis of rotation X.

According to alternative embodiments, however, the transfer wheel could have a different shape, particularly a spherical or ovoid shape. In such cases, the radial surface of the wheel could correspond to the entire surface of the wheel 20.

As illustrated in FIGS. 2 and 3 in particular, the wheel 20 has, on a portion of its radial surface 21 called the useful radial surface 211, a plurality of pockets or hollow compartments 28. These pockets 28 are intended to be filled with product in the intake zone A and to be emptied of their contents in the distribution zone D.

In order to ensure a regular and substantially homogeneous distribution of product in the distribution zone D, the pockets 28 are advantageously evenly distributed over the entire useful radial surface 211 of the wheel 20.

In the particular example under consideration, each pocket 28 has a hemispherical shape, and the pockets are staggered.

The wheel 20 co-operates in a form-fitting manner with the inner surface 13 of the body 12.

In particular, the useful radial surface 211 of the wheel, carrying the pockets 28, cooperates by form-fit with a first radial interaction surface 131 of the body 12 on the side of its passage from the intake zone A to the distribution zone D and with a second radial interaction surface 132 on the side of its passage from the distribution zone D to the intake zone A (see direction of rotation fin FIG. 3).

By co-operating in a complementary manner, it is meant in the present application that the elements concerned have corresponding shapes. On either side of the wheel 20, in the radial direction Y orthogonal to X and Z, the body 12 thus conforms to the curvature of the wheel 20 so that the radial gap between the body and the useful radial surface 211 has a substantially constant width in the Y direction over its entire length in the Z direction.

In a transverse plane of the distribution wheel, the curvilinear length C131, respectively C132 of the radial interface between the transfer wheel 20 and each radial interaction surface 131, 132 is strictly less than half the circumference of the wheel 20.

At the same time, the curvilinear length C131, C132 of the radial interface between the transfer wheel 20 and each radial interaction surface 131, 132, measured in a transverse plane, is at least equal to the maximum curvilinear length C28 of each pocket 28 measured in a transverse plane. In this way, when the wheel 20 makes a complete turn about its axis X, each pocket 28 of the wheel 20 passes through an inlet sector SA where it faces the intake zone A, an intermediate inlet sector SE where it faces the first radial interaction surface 131 of the body 12 and is entirely covered by said surface 131, a distribution sector SD where it faces the distribution zone D and an intermediate exit sector SS, where it faces the second radial interaction surface 132 and is entirely covered by said surface 132 (see FIG. 3).

In the particular example illustrated and as visible in FIG. 2, each end surface 22, 23 of the wheel 20 also co-operates in a form-fitting manner with a respective axial interaction surface 133, 134 of the body.

In the system according to the invention, the body 12 and the wheel 20 co-operate to form a substantially air-tight barrier between the intake zone A and the distribution zone D.

This sealing, which must be ensured both at a standstill and during rotation of the wheel 20, is achieved on two levels:

On the one hand, air is prevented from flowing at the interface between the wheel 20 and the body 12.

In the embodiment shown in FIG. 1, the body 12 and the wheel 20 are dimensionally adjusted for this purpose.

The clearance between each radial interaction surface 131, 132 of the body 12 and the useful radial surface 211 of the transfer wheel 20 is minimized, and amounts to preferably between 0.01 and 0.2 mm, preferably between 0.01 and 0.1 mm.

Preferably, the same is true of the clearance between each end surface 22, 23 of the wheel 20 and the facing axial interaction surface 133, 134 of the body 12.

Also, the curvilinear length C131, C132 of the interface between the transfer wheel 20 and each radial interaction surface 131, 132 is preferably at least 1/20 of the circumference of the wheel 20.

The interface between each interaction surface 131, 132, 133, 134 of the body and the useful radial surface 211 of the wheel 20 is thus sufficiently narrow and long that the pressure gradient at the interface is as high as possible. In this manner, the pressure drops at the interface are then sufficient to prevent air from passing through.

Since the curvilinear length of the interface is also greater than that of a pocket 28 as noted above, preferably equal to at least twice the maximum curvilinear length of the pocket 28 measured in a transverse plane, the wheel 20 and the body 12 are arranged so that each pocket 28 simultaneously communicates with only one or the other of the intake zone A and the distribution zone D.

With such a fit of the parts, in order to avoid pollution of the product by wear particles resulting from friction between the transfer wheel and the body, it is advantageous that at least one of the wheel 20 and the interacting surfaces 131, 132, 133, 134 is/are made of a synthetic material, especially polytetrafluoroethylene (PTFE).

The body may, for example, be made of ceramic or metal, and the wheel 20 of PTFE.

Advantageously, as in the example of FIGS. 1 to 4, the precise fit of the wheel 20 and the body 12 is further enhanced by the presence of seals at the interface between the two parts.

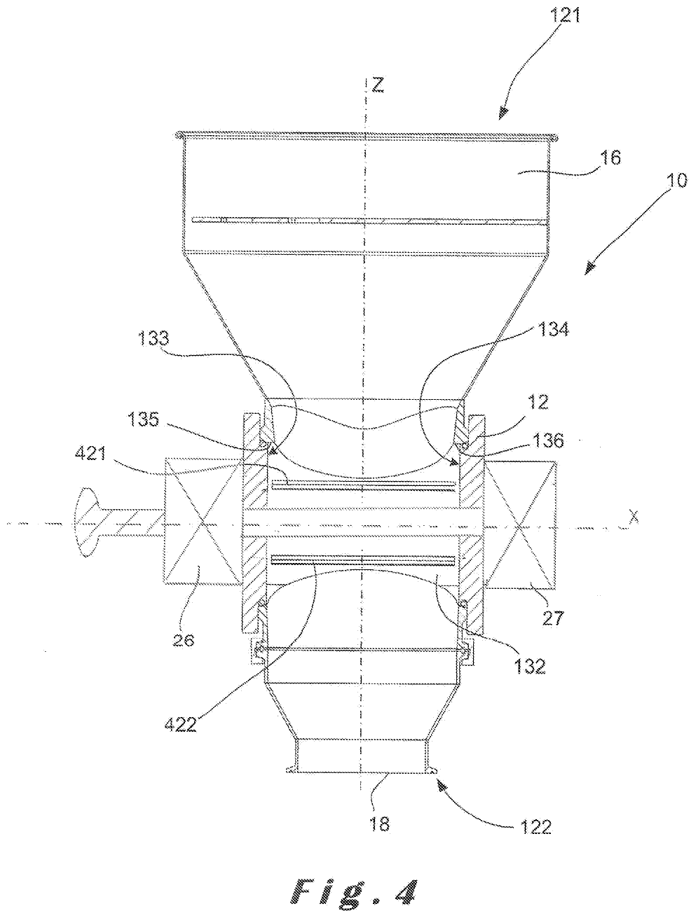

As illustrated in FIGS. 3 and 4, each radial interaction surface 131, 132 here carries two linear seals 411, 412, respectively 421, 422, extending in axial direction X over a length at least equal to the axial length of the useful radial surface 211 of the wheel 20 and configured to cooperate with said useful radial surface 211. These seals are advantageously wiper seals. The two seals 411, 421, respectively 421, 422 of the same pair are spaced apart by a curvilinear distance C41 respectively C42—measured in a transverse plane—at least equal to, preferably greater than, the curvilinear length C28 of a pocket 28 of the wheel 20 measured in a transverse plane. Such an arrangement ensures that each pocket 28 always communicates with only one of the intake A and distribution D zones, even in a case where the body 12 and the wheel 20 are not dimensionally fitted.

According to an alternative arrangement, a plurality of linear seals could also be provided on the radial surface 21 of the transfer wheel 20, evenly distributed around its circumference, and configured to co-operate with the radial interaction surfaces 131, 132 of the body to achieve sealing.

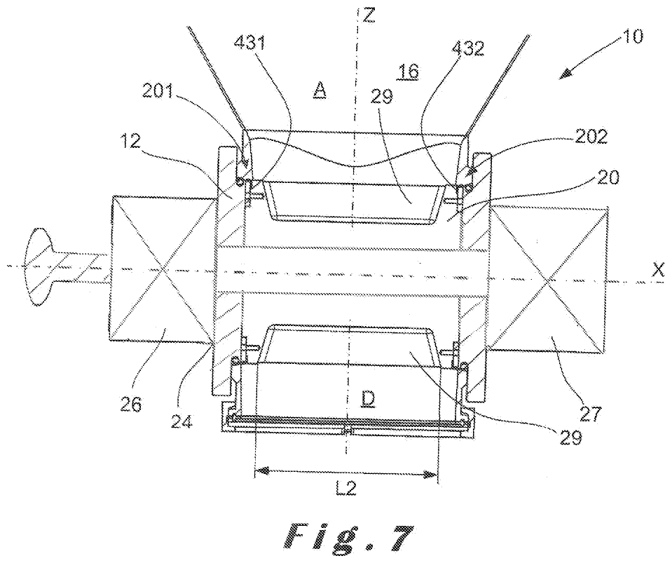

A circular seal 431, 432 (forming a closed contour in a transverse plane of the wheel, see FIGS. 5 and FIG. 7), may also be provided at each lateral end 201, 202 of the wheel 20.

As illustrated in FIG. 5, the lateral ends 201, 202 of the wheel 20 may be inserted over a short axial length, into a corresponding portion of the body 12. In other words, at each lateral end 201, 202 of the wheel 20, the radially outer surface 212 of the wheel 20 co-operates in a form-fitting manner with a cylindrical inner surface 135, 136 of the body 12. A radial seal 431, 432 mounted at the periphery of the wheel 20 may thus radially co-operate with said facing cylindrical inner surface 135, 136.

FIG. 5 illustrates the arrangement of a circular seal 431 at the lateral end 201 of the wheel. The circular seal 431 is here a lip seal, with a substantially L-shaped cross section. However, it could be an O-ring or any other suitable type of seal. According to the illustrated arrangement, a first planar annular portion 4311 of the seal is secured to the lateral end surface 22 of the wheel 20 by means of a washer 441 applied against said first portion 4311 on the one hand and against said end surface 22 on the other hand and secured to said surface by screws 451. A second cylindrical portion 4312 of the seal, prolonging said first portion, forms a lip projecting with respect to the useful radial surface 211 of the wheel and adapted to be applied by deforming against the internal surface 135 of the body. The elasticity of the lip presses it against the surface of the body, thus ensuring sealing.

As a variant, a circular seal could be provided on each lateral end surface 22, 23 of the wheel 20, to co-operate with an opposing surface 133, 134 of the body 12.

In the first embodiment described above, sealing between the wheel surface 20 and the body 12 is achieved by a dimensional fit of the parts and by a seal assembly. According to an alternative embodiment, sealing could also be achieved solely by a dimensional fit of the parts, or solely by a set of seals, or by a combination different from that described in connection with the first embodiment (for example: the dimensional fit could be omitted between the facing lateral end surfaces of the wheel 20 and the body 12).

Even if the air flow between the body 12 and the wheel 20 is managed, such as by dimensional adjustment of the two parts or by a seal system or a combination of these solutions, some amount of air also passes through the pockets 28 carrying the product. In particular, even when a pocket 28 is full of powder, it still contains at least some air.

Particularly advantageously, to prevent such air from entering the distribution zone (which is typically a vacuum processing chamber), the transfer system 10 includes an air extraction system 50 for extracting the air contained in the at least one pocket 28 prior to its arrival in the distribution zone D.

In the illustrated example, as seen in particular in FIG. 3, the extraction system 50 is integrated in the body 12: it comprises an extraction conduit 51 opening into the cavity 14 and fluidly connected with a vacuum pump (not shown), and a filter 52 to prevent the product from coming out of the pocket, forming a part of the first radial interaction surface 131.

The conduit 51 is adapted to communicate with each pocket 28 to be emptied when that pocket is on the intermediate inlet sector SE, where it faces the first radial interaction surface 131, in other words, as it passes from the intake zone A to the distribution zone D.

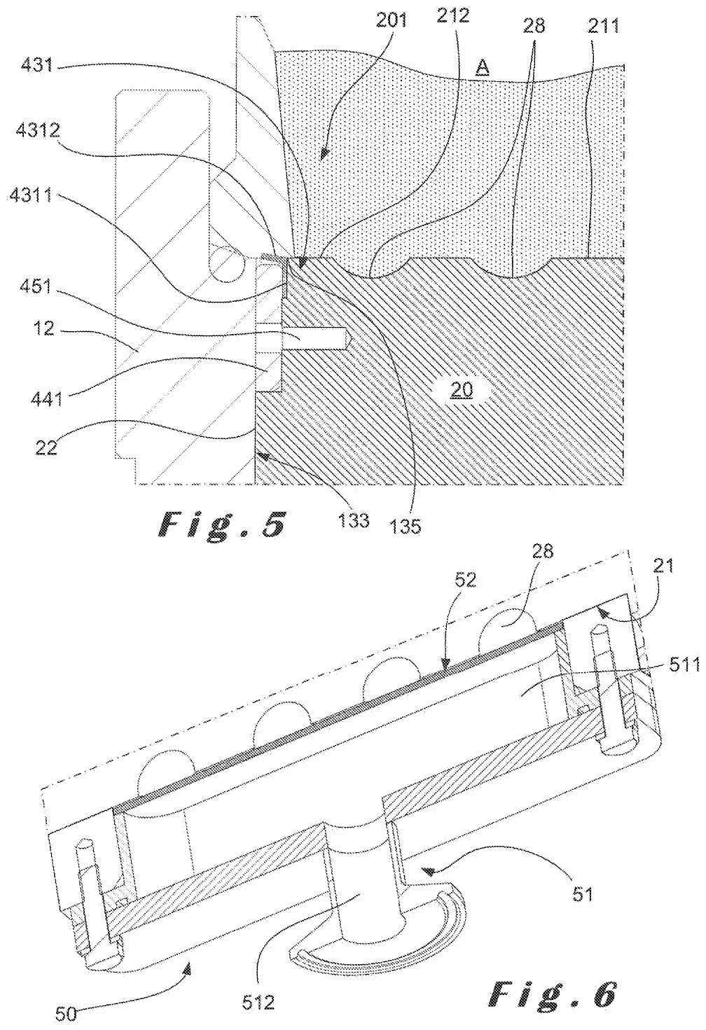

In order to be able to evacuate all the pockets 28 of the wheel 20 during the rotation of the latter, the conduit 51 comprises at least one section of length—measured in the axial direction X—substantially equal to the axial length of the useful radial surface 211 over which the pockets 28 of the wheel 20 extend. As can be seen in FIG. 6, the conduit 51 comprises such a section 511 terminated by the filter 52 and prolonged by a second section with a reduced diameter allowing connection to the vacuum pump.

When a pocket 28 arrives opposite the conduit 51, on the inlet sector SE, it no longer communicates with the intake zone A, and does not yet communicate with the distribution zone D. Either the clearance between the body and the wheel prevents the passage of air between zones A and D and the pocket 28, or axial seals 411, 412 are arranged on either side of the pocket 28 and on either side of the conduit 51 so as to form a tight intermediate lock between the two zones A and D, or both. The air contained in the pocket 28 is then sucked out by the action of the vacuum pump. The product itself is stopped by the filter 52 and thus remains inside the pocket 28.

As an alternative or in addition, an extraction conduit could also be integrated into the transfer wheel 20, with the filter forming at least part of the bottom of each pocket 28.

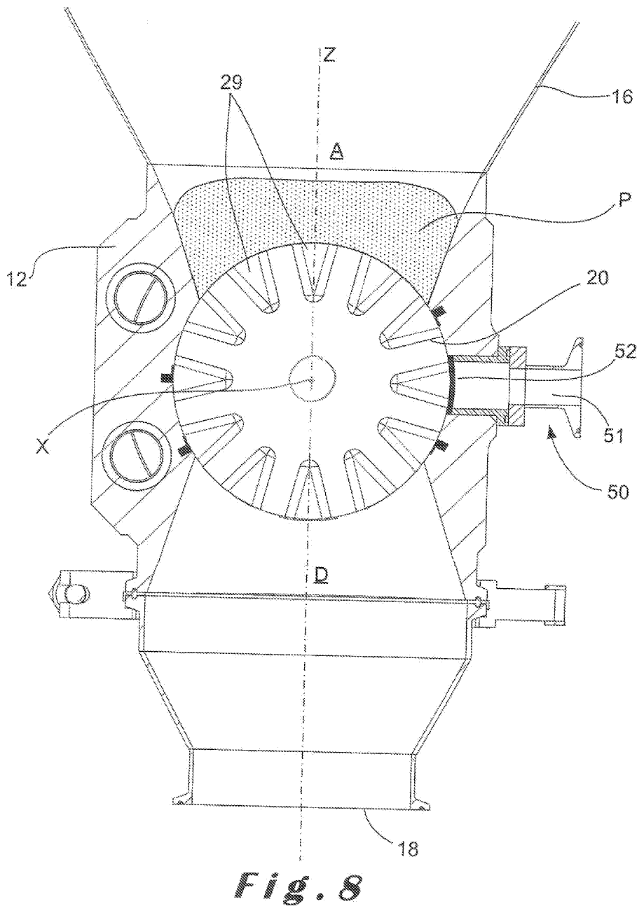

FIGS. 7 and 8 illustrate a transfer system according to a second embodiment of the invention, similar to that described in connection with FIGS. 1 to 6, but in which the pockets are of different shapes. All numerical references referring to elements identical or similar to the elements previously described are numbered with the same references in these figures and are not described again.

In this example, as seen in FIG. 7, each pocket 29 is in the form of an elongated groove, extending in the axial direction X of the wheel 20. More specifically, each pocket extends in the axial direction for a length L2 equal to at least 50% of the axial length L1 of the wheel 20.

In cross section, as illustrated in FIG. 8, the pockets have, for example, an outwardly flaring, substantially V-shaped profile.

FIG. 9 schematically illustrates a processing system 100 comprising a processing chamber 90 and at least one transfer system 10 according to the invention for feeding this chamber 90.

The processing chamber 90 is delimited by a frame 93 and comprises an inlet 91 for the introduction of the product P to be processed and an outlet 92 for the evacuation of the processed product.

In this case, the inlet 91 of the processing chamber 90 is located near the upper end of this chamber 90, and the outlet 92, near its lower end.

The inlet 91 of the processing chamber is closed by the first transfer system 10a according to the invention, the wheel of which acts as a dosing device.

According to an advantageous arrangement, the outlet 92 of the chamber 90 is closed by a second transfer system 10b according to the invention. Alternatively, the outlet 92 of the chamber 90 could also be closed by a tight valve or by an airlock closed by two valves, the evacuation of the product not necessarily being carried out continuously.

The processing chamber 90 houses at least one device 94 for processing the product. The product to be treated is, for example, a powder, formed of grains with a maximum diameter of, for example, between 100 and 1000 microns.

According to an example of use, the chamber 90 is for example a grinding chamber and this processing device 94 is a grinder. In the case of a powder of the aforementioned type, the grinder 94 is, for example, adapted to obtain a maximum grain diameter of, for example, between 10 and 100 microns after processing.

In the particular example shown, product dispensed into the processing chamber 90 by the first transfer system 10a falls by gravity into the processing device 94 situated below and then toward the outlet.

The interior of the processing chamber 90 communicates with a vacuum pump 97 through a conduit 95 leading to an opening 96 in the chamber 90. To prevent product suction when the pump 97 is operating, the opening 96 may be protected by a filter system 99.

In the processing system described above in relation to FIG. 9, the processing chamber 90 is preferably put under vacuum, at an absolute pressure of between 0.05 and 0.3 bar during the product processing operation. This vacuum prevents deterioration of the product by oxidation and limits the risks of explosion in the case of flammable products.

The reservoir 16—which forms the product intake zone A for the first system 10a—is, in turn, open to the outside, and thus typically at atmospheric pressure.

The system 10a closes the inlet 91 of the processing chamber so as to allow its being put under vacuum and maintaining this vacuum, while allowing the continuous distribution of product P inside the chamber 90

Similarly, the second transfer system 10b allows the processed product to be discharged to a downstream receiving device 98 while ensuring sufficient air-tightness for putting under vacuum and maintaining the chamber 90 under vacuum.

The use of such a processing system is as follows:

The processing chamber is put under vacuum by means of the vacuum pump 97.

The reservoir 16 is filled with the product to be processed.

The transfer wheel 20 of the first transfer system is set in rotation by the drive motor 25. By gravity, the pockets 28 of the wheel 20 are filled with product P. Advantageously, the air extraction system 50 is activated to achieve a vacuum of the interior of each pocket before its arrival in the processing chamber.

At the same time, the processing device is activated to be able to immediately and continuously process the product P dispensed by the wheel 20.

If necessary, the transfer wheel of the second system 10b is simultaneously set in rotation to continuously discharge the processed product to a downstream receiving device 98.

If the distribution systems 10a and 10b are perfectly sealed, for example thanks to the implementation of a set of seals as described above, the chamber remains under vacuum throughout the processing, in particular thanks to the air extraction systems 50 which carry out an intermediate putting under vacuum of each pocket between the reservoir 16 and the processing chamber 90, respectively between the processing chamber 90 and the outside of the chamber.

If either of the distribution systems 10a, 10b allows some air to enter, between the body and the wheel and/or through the pockets, then the process includes compensating for this air entry by activating the vacuum pump 97 during the processing operation.

1. A system for transferring product, said transfer system comprising:
a body defining a cavity extending in a main direction, and
a transfer wheel accommodated at least partially in said cavity and separating in said main direction a product intake zone and a product distribution zone, the transfer wheel being provided with at least one pocket at its periphery and being adapted to rotate about an axis substantially orthogonal to said main direction so that said pocket feeds product from said intake zone to said distribution zone, wherein the transfer wheel and the body co-operate to form a substantially air-tight barrier between the intake zone and the distribution zone.

2. The transfer system according to claim 1, wherein the transfer wheel and the body co-operate by dimensional fit and/or by a seal system to form said substantially air-tight barrier.

3. The transfer system according to claim 1, comprising an air extraction system for extracting air contained in the at least one pocket prior to its arrival in the distribution zone.

4. The transfer system according to claim 3, wherein the extraction system comprises at least one extraction conduit fluidly connected with a vacuum pump, and at least one filter to prevent product from exiting the pocket.

5. The transfer system according to claim 4, wherein the at least one extraction conduit is formed in the transfer wheel, and the filter forms at least a portion of a bottom of said at least one pocket.

6. The transfer system according to claim 1, wherein a useful radial surface of the transfer wheel co-operates in a form-fitting manner with a first radial interaction surface of the body on a side of its passage from the intake zone to the distribution area, and a second radial interaction surface of the body on the side of its passage from the distribution zone to the intake zone.

7. The transfer system according to claim 6, wherein a curvilinear length, measured in a transverse plane, of each radial interface between the useful radial surface of the transfer wheel and each said radial interaction surface is at least equal to a maximum curvilinear length of the at least one pocket measured in a transverse plane.

8. The transfer system according to claim 6, wherein a clearance between at least one of the first and second radial interaction surfaces of the body and the useful radial surface of the transfer wheel is between 0.01 and 0.2 mm.

9. The transfer system according to claim 6, wherein a curvilinear length, measured in a transverse plane, of each radial interface between the useful radial surface of the transfer wheel and each said radial interaction surface of the body is at least equal to 1/20 of a circumference of the wheel.

10. The transfer system according to claim claims 6, wherein the extraction system comprises at least one extraction conduit fluidly connected with a vacuum pump, and at least one filter to prevent product from exiting the pocket, and said at least one extraction conduit opens onto the first radial interaction surface of the body.

11. The transfer system according to claim 6, wherein at least one linear seal extending in an axial direction of the transfer wheel is arranged on at least one of the first and second radial interaction surfaces or on the useful radial surface of the transfer wheel.

12. The transfer system of claim 1, said at least one pocket comprising a plurality of pockets arranged in a staggered pattern and evenly distributed around a circumference of the transfer wheel.

13. A system for processing a product under vacuum, comprising:
a frame,
a processing chamber delimited by the frame and adapted to be connected in fluid connection with a vacuum pump, the processing chamber being provided with an inlet for introduction of product to be processed and an outlet for discharge of the processed product,
the product transfer system according to claim 1, arranged to close the inlet of the processing chamber, and
means for closing said outlet.

14. The processing system according to claim 13, wherein the processing chamber is a grinding chamber that includes a grinder.

15. The processing system according to claim 13, said means for closing said outlet comprising a second said product transfer system arranged to close the outlet of the processing chamber.

16. A method of vacuum processing of a product by means of the processing system according to claim 13, comprising at least one step a) during which are simultaneously performed:
rotation of the transfer wheel for continuous supply of product into the processing chamber previously put under vacuum, and
continuous processing of the product fed by the transfer wheel.

17. The processing method according to claim 16, wherein step a) further comprises removing of air in each pocket of the transfer wheel prior to its arrival in the distribution area.

18. The processing method according to claim 16, wherein step a) further comprises suctioning of air contained in the processing chamber during processing of the product.

19. The processing method according to claim 16, wherein throughout step a) an absolute pressure differential between the intake zone and the processing chamber is maintained between 0.7 and 0.95 bar.

20. The transfer system according to claim 8, said clearance being between 0.01 and 0. 1 mm.
